(19) United States
(12) Patent Application Publication
(10) Pub. No.: US 2021/0394090 A1
(43) Pub. Date: Dec. 23, 2021

(54) LIQUID FILTER

(71) Applicants: ILAN Z. GOLAN, Long Beach, CA (US); SHIMON Z. GOLAN, Long Beach, CA (US)

(72) Inventors: ILAN Z. GOLAN, Long Beach, CA (US); SHIMON Z. GOLAN, Long Beach, CA (US)

(21) Appl. No.: 16/904,553

(22) Filed: Jun. 17, 2020

(51) Int. Cl. B01D 29/05; B01D 27/14; B01D 29/11; B01D 29/21; B01D 29/58; B01D 29/96

(52) U.S. Cl. CPC B01D 29/055; B01D 27/148; B01D 29/111; B01D 27/103; B01D 29/58; B01D 29/96; B01D 29/21

(57) ABSTRACT

A fuel filter device for operation in a position under non-extreme conditions, when there is enough time for replacement of the clogged filter element, or in a reverse position in a fuel bypassing state for non-stop operation under extreme conditions, when there is no time for replacement of the clogged filter element. The device consists of cup-shaped members, which are interconnected through a threaded connection and form a cavity that contains a spring compressed between the bottom of an opening of one of the cup-shaped members and an abutment formed between two openings of another cup-shaped member. The compression force of the spring is applied to a seal ring placed into an annular groove formed in the abutment surface through a flange of the filter element. Another improved sealing feature is provided by a second seal ring, which seals the threaded connection, when the connection is tightened.

### FIELD OF THE INVENTION

The invention relates to a liquid filter, in particular to a liquid filter to be selectively preinstalled in one of two installation positions. More specifically, the invention relates to a liquid filter that can be installed in one position for use under non-extreme conditions when there is enough time for replacing a clogged filter element and in a reversed position for use under critical conditions, when there is no time for replacing a clogged filter element. More specifically, the liquid filter of the invention may find application in aerospace industry or in automotive industry as a fuel filter for use in extreme filtration environment, e.g., on racing cars or motorcycles where the filter may be subject to the effect of high temperatures, high pressures, vibrations, etc.

### DESCRIPTION OF THE PRIOR ART

A purpose a liquid filter used in any application is to prevent the liquid delivered to the destination from bringing the liquid with any contaminants or inclusions that may be detrimental to the destination object.

For examples, a purpose of a fuel filter installed in a vehicle is to admit into the engine only a purely cleaned fuel and thus to protect the mating parts of the engine from contamination and damage by products of dust, dirt, rust particles, etc., that otherwise could be brought into the engine with a flow of fuel.

In a motorcycle, depending on the motorcycle type, a fuel filter may be installed either between a fuel pump and a fuel injector, or between a fuel tank and a carburetor.

There exist varieties of various liquid filters that consist mainly of a filter body, filter body cap, and a filter element installed inside the interior defined by the filter body and the cap. The fuel is supplied into the filter interior through an input fitting, passes through the filter element where it is cleaned from the entrapped contaminants, and then flows out from the filter through an outlet fitting in a purified state.

When the filter element is clogged, the filter is released from hoses, disassembled, and the filter elements is either washed out and reinstalled or is replaced with a new element or preassembled cartridge.

For use under possible emergency conditions, when there may be no time for immediate replacement of the clogged filter element, there exist a plurality of various liquid filters switchable to a bypass mode of operation for bypassing the clogged filter element. Such filters are more complicated in construction and provided with auxiliary filter elements. An access to such auxiliary filter elements is provided through a bypass channel, which is opened under the effect of a liquid pressure built due to closing the direct path by the clogged filter. The increased pressure biases a compression spring or spring-loaded member and thus opens the aforementioned bypass channel.

For example, US Patent Application Publication 2005/0103701A1 discloses a liquid filter arrangement that consists of a housing, a primary filter element, a secondary filter construction and a bypass valve arrangement. The components are arranged such that in normal operation, liquid flows through the primary filter element and then through the secondary filter construction, and such that during bypass valve operation and before leaving the liquid filter arrangement, the flow circumvents the primary filter element and is directed through the secondary filter construction. Both a disposable spin on embodiment and a serviceable cartridge embodiment are provided.

U.S. Pat. No. 7,596,202B1 describes a remote filter usable, by way of example, as a remote oil filter or a remote fuel filter for internal combustion engines, or for hydraulic systems. As may be seen from the following description, the filter includes a reusable filter element and a bypass valve to allow flow, particularly oil flow, to be maintained in the event the filter unexpectedly becomes substantially plugged.

US 2016/0059164A1 discloses a fluid filter assembly that is comprised of an outer housing, a filter element including a face, and a filter portion extending from the face. The housing has an inlet and an outlet. A spring biases the face against a housing structure at the inlet. A pressure drop across the filter assembly biases the filter element against the spring force such that if the pressure drop exceeds the spring force, the filter element can move to a bypass position. A hydraulic system is also disclosed.

U.S. Pat. No. 8,083,938B2 discloses a filter assembly, filter element and methods. The filter assembly includes a filter base in which a filter element is mounted. The filter element includes a bypass valve carried by the filter element that operates independent of and free of interaction with the filter base. Methods include providing an entirely new bypass valve for the filter assembly by inserting a filter element including a complete bypass valve into the filter base such that bypass valve structures of the filter base are rendered useless or superfluous. The bypass acts to allow dirty fluid to short-circuit the filter element of the filter assembly when the filter element becomes clogged with contaminants. Although it is not typically preferred to allow dirty fluid to flow through the filter without being filtered, it is more preferable than preventing a sufficient amount of fluid such as lubricating oil or fuel to flow through the system, which can result in catastrophic engine failures.

U.S. Pat. No. 5,972,213 discloses a liquid filter that consists of a housing, an inlet orifice, an outlet orifice, a spring, and a pleated disk filter, which is positioned within the housing between the spring and an abutment surface. The filter has a bypassing possibility. The filter may be bypassed in the event there is complete flow blockage at the upstream side of the filter, and the pressure on the blocked filter exceeds the force of the spring. Under these conditions, the filter will simply tilt slightly off a vertical orientation so that some fuel will pass over the edge of the filter and through the filter downstream. This is known as the “racing option”, orientation and is for use in racing or other situations in which the operator wants to maintain flow of fuel to the engine, even at the expense of severe damage and/or destruction of the engine due to impurities flowing through the fuel line. In a non-racing option, the filter is placed in the fuel line so that the spring is on the upstream side of the filter, i.e., in the opposite orientation to the racing option.

### SUMMARY OF THE INVENTION

The present invention provides a liquid filter that allows installation of the filter for operation under normal conditions (when there is enough time for replacing a filter element when it is clogged), and for operation under extreme conditions, (e.g., when the filter element is clogged and the filter can automatically switch to a bypass mode for passing the liquid to the destination around the clogged filter element). In other words, when the liquid filter is installed in one position, it operates only in a non-bypass mode, and when it is installed in reverse, it operates in a non-bypass mode until the filter element is clogged and is automatically switched to a bypass mode when the filter element is clogged. Thus, without change in design, depending on the position in a liquid supply system the same liquid filter may operate in a normal, i.e., direct-flow mode or, when necessary, in a bypass mode.

Hereinafter, the liquid filter of the invention will be referred to as a fuel filter. It is understood, however, that fuel is mentioned only as an example and that any other liquid, e.g., oil, water, solution, or the like, may constitute a filtration medium.

More specifically, the fuel filter of the invention consists of a filter body with a fuel outlet fitting and a body cap that is connected to the filter body, e.g., through a threaded connection, and has a fuel input fitting. In the aforementioned threaded connection, the filter body may have an external thread and the body cap may have an internal thread, or vice versa. In the first case, the cap is screwed onto the filter body, and a first seal ring that prevents metal-to-metal contact and seals the threaded connection is placed between the ends of the external and internal threads at a place where the end face of the body cap meets the end face of the filter body. When the threads are strongly tightened, the first O-ring is deformed and expands in a radial outward direction thus tightly sealing the connection against penetration of the liquid through the threads.

The filter body has a cup-shaped configuration with a large-diameter opening on an open end of the filter body and a small-diameter opening bored in the large-diameter opening deeper into the filter body in the direction of the outlet fitting leaving a flat annular shoulder on the bottom of the large-diameter opening. An annular groove is formed on this flat annular shoulder for placing a second seal O-ring, the purpose of which will be described later. The filter body cap also has a cup-shaped configuration with an opening and a bottom surface at the end of the opening. The annular groove may have a depth of up to half-diameter of the second O-ring cross-section.

Installed inside the filter interior cavity is a filter element, which is made in the form of a porous pleated disk-like body, provided with a plurality of serrations or ribs. The ribs extend outward from the end faces of the filter element and intend for increasing the filtering surface areas. On its outer peripheral surface, the filter element is provided with an annular flange. This flange is squeezed between the aforementioned second seal O-ring ring and an end of a coil spring, which is inserted into the interior cavity of the filter and compressed between the mating side of the flange and the bottom of the cap opening. The outer edge of the flange is not in a sealing engagement with the inner wall of the large-diameter opening of the filter body leaving a small gap between them.

A distinguishing feature of the fuel filter assembly of the invention is that this assembly allows pre-installation of the filter cap-body unit for operation under normal, i.e., direct flow conditions, when the fuel passes through the filter element and there is enough time for replacing a clogged filter element, and for operation under extreme conditions, e.g., when the fuel filter is installed on a vehicle that participates in racing and there is no time for replacing the clogged filter element. In that case the filter is preinstalled in a reversed position, and when the supply of fuel flow is discontinues, the filter will automatically switches to bypass the flow around the clogged filter. For securing connection of a fuel-supply hose, the fuel input fitting on the cap side may have double O-ring seals.

More specifically, for use under extreme conditions of racing, when the priority is a victory and the malfunction of the fuel filter is a secondary problem, a racer preinstalls the fuel filter in a backward, e.g., a reversed position, at which the fuel supply line is connected to the fitting on the filter cap side. Until the filter element is not clogged, the filter operates normally and allows the fuel to flow from fuel tank to the carburetor or from the fuel pump to the fuel injector. However, when the filter element is clogged and a pressure of the accumulated fuel increases, the increased pressure acts on the facing end face of the filter element and shifts the filter element toward the now-outlet side of the filter body cap, i.e., in the direction opposite the coil spring and away from the second seal O-ring. As a result, the spring is biased in the fuel supply direction, the second seal O-ring does not work anymore as a seal, and a bypass channel is opened for the flow of the fuel beyond the filter element through the gap between the flange of the filter element and the interior surface of the large opening of the filter body.

Upon completion of the racing, the cap-body unit can be reinstalled into its original position for use under normal condition and for cleaning the fuel from possible contaminants prior to input of the fuel to the engine system.

Thus, the liquid filter of the invention is a versatile device which is simple in construction, inexpensive to manufacture, and reliable in operation under normal as well as under harsh extreme conditions.

### BRIEF DESCRIPTION OF THE DRAWINGS

FIG. 1 is a three-dimensional partial sectional view of a liquid filter of the invention with filter components in positions for use under non-extreme conditions when bypassing of the filter element is not necessary.

FIG. 2 is an encircled area A of FIG. 1 shown on a larger scale.

FIG. 3 is a diametrical cross-sectional view of a pleated filter element of the liquid filter of the invention

FIG. 4 is three-dimensional partial sectional view of a liquid filter of the invention with filter components in positions for use under extreme conditions with a possibility of bypassing the filter element in case of clogging.

### DETAILED DESCRIPTION OF THE INVENTION

The invention relates to a liquid filter, in particular to a liquid filter to be selectively preinstalled in one of two installation positions. More specifically, the invention relates to a liquid filter that can be installed in one position for use under non-extreme conditions when there is enough time for replacing a clogged filter element and in a reversed position for use under critical conditions, when there is no time for replacing a clogged filter element.

Hereinafter, the liquid filter of the invention will be referred to as a fuel filter. It is understood, however, that fuel is mentioned only as an example and that any other liquid, e.g., oil, water, solution, or the like, may constitute a filtration medium.

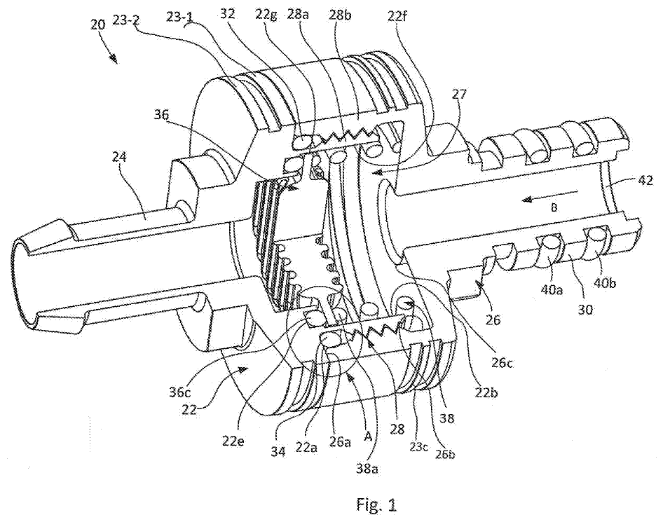

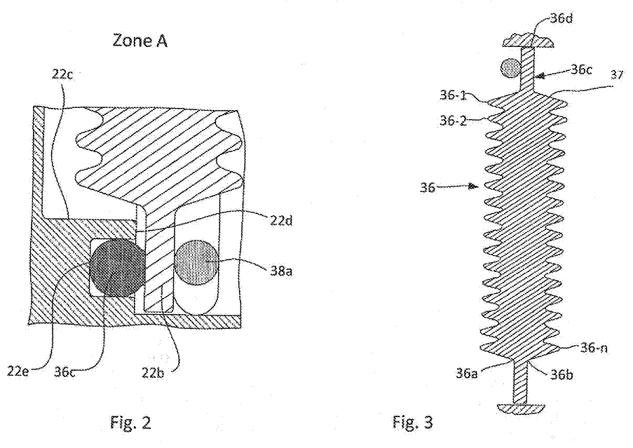

The fuel filter of the invention will be further described in detail with reference to the attached drawings, wherein FIG. 1 is a three-dimensional partial sectional view of a liquid filter of the invention with filter components in positions for use under non-extreme conditions when bypassing of the filter element is not necessary FIG. 2 is an encircled area A of FIG. 1 shown on a larger scale, and FIG. 3 is a diametrical cross-sectional view of the filter element used in the liquid filter of FIG. 1.

In order not to complicate the images in the drawings, the cross-sectional areas are not hatched.

As can be seen from FIG. 1, where the entire fuel filter is designated by reference numeral 20, the fuel filter consists of a filter body 22 with a filter outlet fitting 24 and a body cap 26 that is connected to the filter body 22, e.g., through a threaded connection 28, and has a filter input fitting 30. In the aforementioned threaded connection, the filter body 22 may have an external thread 28a and the body cap 26 may have an internal thread 28b, or vice versa. In the first case, the cap 26 is screwed onto the filter body 22. Reference numerals 23=1, 23-2, . . . 23-n designate cooling fins formed on the outer surfaces of the filter body 22 and the filter cap 26 (FIG. 1).

The threaded connection 28 is provided with a first seal O-ring 32 that prevents metal-to-metal contact between the filter body 22 and the cap 26 and seals the threaded connection 28. The seal O-ring 32 is placed between the ends of the external and internal threads 28a and 28b, respectively, at a place where the end face 26a of the body cap 26 meets the end face 22a of the filter body 22. When the threads are strongly tightened, the first seal O-ring 32 is deformed and expands in a radial outward direction thus tightly sealing the connection against penetration of the liquid through the threads.

The filter body 22 has a cup-shaped configuration with a large-diameter opening 22b (FIG. 1) on an open end of the filter body 22 and a small-diameter opening 22c (FIG. 2) bored in the large-diameter opening 22b deeper into the filter body 22 in the direction of the outlet fitting 24 leaving a flat annular shoulder 22d on the bottom of the large-diameter opening 22b. An annular groove 22e is formed on this flat annular shoulder 22d for placing a second seal O-ring, the purpose of which will be described later. Details of the groove 22e, seal O-ring 34, the large-diameter opening 22b, and the small-diameter opening are shown in FIG. 2, which is an encircled area A of FIG. 1 depicted on a larger scale. The annular groove 22e may have a depth of up to half-diameter of the cross-section of the second O-ring 34.

The filter body cap 26 also has a cup-shaped configuration with an opening 26b and a bottom surface 26c at the end of the opening 26b. The openings 22b (FIG. 1), 22c (FIGS. 2), and 26b (FIG. 1) define a filter interior cavity 27. Installed inside the filter interior cavity 27 is a filter element 36, which is shown in a diametrical cross section in FIG. 3. The filter element 36 is made in the form of a porous pleated disk-shaped body, provided with a plurality of serrations or ribs 36-1, 36-2, . . . 36-n, which extend outward from the end faces 36a and 36b of the filter element 36 and are intended for increasing the filtering surface areas. On its outer peripheral surface 37, the filter element is provided with an annular flange 36c. This flange is squeezed between the aforementioned second seal O-ring ring 22e and an end of a coil spring 38, which is inserted into the filter interior cavity 27 of the filter and compressed between the mating side of the flange 36c (FIGS. 1 and 3) and the bottom 26c (FIG. 1) of the cap opening. In this case, the shoulder 22d (FIG. 2) functions as an abutment surface for the end 38a of the spring 38. The outer edge 36d of the flange is not in a sealing engagement with the inner wall 22f of the large-diameter opening 22b of the filter body 22 leaving a small gap 22g between them.

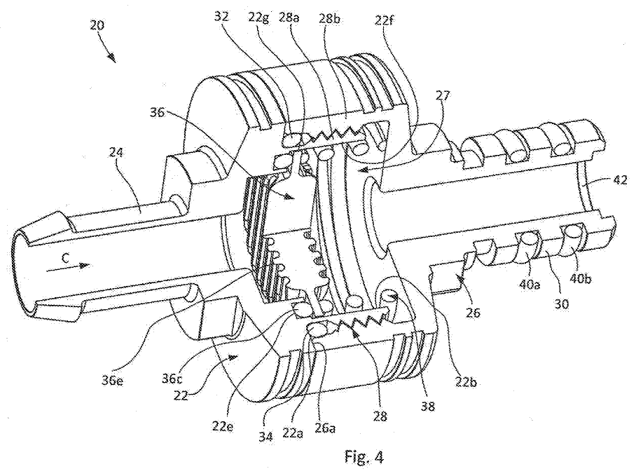

For securing connection of a fuel-supply hose (not shown), the filter input fitting 30 on the cap side may have double O-ring seals 40a and 40b (FIG. 1). Reference numeral 42 designates a seat for a prefiltration element (not shown). In the situation of FIG. 4, the fitting 24 functions as a filter inlet fitting, and the fitting 30 functions as a filter outlet fitting.

A distinguishing feature of the fuel filter 20 of the invention is that this filter allows pre-installation of the filter 20 for operation under normal, i.e., direct flow conditions, when the fuel passes through the filter element 36 in the direction of arrow B (FIG. 1) from the inlet fitting 30 (which in this case is on the side of the fuel pump [not shown]) and there is enough time for replacing the filter element 36, when it is clogged, and for operation under extreme (racing) conditions, e.g., when the fuel filter is installed on a vehicle that participates in racing and there is no time for replacing the clogged filter element. In that case, the filter 20 is preinstalled in a reversed position shown in FIG. 4. i.e., so that the filter element 36 faces directly to the flow of fuel, which in that case is supplied to the engine through the filter in the direction of arrow C. When in this position of the filter 20 the filter element 36 is clogged to the extent that the supply of fuel to the engine is discontinues, the filter 20 will automatically switch to a bypass mode of operation with the flow of the fuel around the clogged filter.

More specifically, for use under extreme conditions of racing, when the priority is a victory and the malfunction of the fuel filter is a secondary problem, a racer preinstalls the fuel filter 20 in a backward, e.g., a reversed position, at which the fuel supply line is connected to the fitting 24 on the filter cap side. Until the filter element 36 is not clogged, the filter operates normally and allows the fuel to flow from fuel tank to the carburetor (not shown) or from the fuel pump to the fuel injector (not shown). However, when the filter element 36 is clogged and a pressure of the accumulated fuel increases, the increased pressure acts onto the facing side 36e (FIG. 4) of the filter element 36 as on a piston and shifts the filter element 36 toward the now-outlet side of the filter body cap, i.e., in the direction of arrow C against the coil spring 38 and away from the second seal O-ring 36c. As a result, the spring 38 is biased in the fuel supply direction of arrow C, the second seal O-ring 36c does not work anymore as a seal, and a bypass channel is opened for the flow of the fuel beyond the filter element 36 through the gap 22g between the flange 36d of the filter element 36 and the inner wall 22f of the large-diameter opening 22b of the filter body 22.

Upon completion of the racing, the cap-body unit can be reinstalled into its original position (FIG. 1) for use under normal conditions and for cleaning the fuel from possible contaminants prior to delivery of the fuel to the engine system.

Thus, it has been shown that the liquid filter 20 of the invention is a versatile device which is simple in construction, inexpensive to manufacture, and reliable in operation under normal as well as under harsh extreme conditions.

According to one embodiment of the invention, the fuel sensor has the filter body and the filter body cap made from aluminum, e.g., Aluminum 6061-T6 with surfaces finished by anodizing. The filter element is made from pleated 304 stainless steel mesh laminate having total thickness of 4,318 mm, flange thickness of about 1 mm, and filtering holes of 0.01 mm in diameter. The total effective filtration area is 645.15 mm². The element provides a maximum flow of 3.785 liters per minute. The element is washable, reusable indefinitely, and cleaned easily with air or soluble rinse.

Thus, it has been shown that the liquid filter of the invention is the fuel filter 20 that has a first cup-shaped member, i.e., the filter body 22 that has a first opening 22b and a first connection member, i.e., the external thread 28a on one end and a liquid outlet portion, i.e., the outlet fitting 24, on the end opposite to the threaded end of the filter body 22. The filter 20 has a small-diameter opening 22c (FIG. 2) bored in the large-diameter opening 22b deeper into the filter body 22 in the direction of the outlet nipple 24. An annular shoulder 22d (FIG. 2) that functions as an abutment surface is formed on the bottom of the large-diameter opening 22b, and annular groove 22e for placing a seal O-ring 34. The purpose of this seal ring is to seal the filter element 36 against passage of the fuel around the flange 36c of the filter element to the outlet fitting 24. Another seal ring 32 is placed between the front end of the internal thread 28b formed in the cap 26 and the rear end of the external thread 28a of the filter body 22. The seal ring 32 seals the threaded connection of the filter body 22 with the filter body cap 26 when both threads are strongly tightened.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the body and cap can be made from material other than aluminum, e.g., a light alloy. The filter element may have different shape, made of a material different from the pleated 304 stainless steel mesh. The filters may be different in size and throughput capacity, can be installed on a carburetor-fuel supply systems or on fuel-pump supply systems, on cars, or motorcycles, etc. The fittings on both sides of the filter may be identical or different and intended for connections hoses or pipes. Finally, the liquid filter build on the principle of the invention is applicable for filtering liquids other than fuels, e.g., oils, aqueous solutions, or any other contaminated liquids that need to be cleaned before admission to the destination equipment. The cup-shaped body and cap may have a square cross-section and are interconnected and fixed together through a device other than threads.

What we claim is:

1. A liquid filter comprising:
a first cup-shaped member having a first opening and a first connection member on one end and a liquid outlet portion on an end opposite to said one end of the first cup-shaped member; the first cup-shaped member having an abutment surface in the first opening;
a second cup-shaped member having a second opening and a second connection member on one end and a liquid inlet portion on an end opposite to said one end of the second cup-shaped member, the second opening having a bottom, the first connection member being engageable with the second connection member;
a liquid filter interior cavity formed by the first opening and the second opening when the first connection member is engaged with the second connection member;
a first seal member for sealing the first connection member and the second connection member when the first connection member is engaged with the second connection member;
a groove, which is formed in the abutment surface and has a depth;
a second seal member, which is inserted into the groove and has a thickness greater than the depth of the groove;
a filter element for a liquid to be filtered, the filter element having a peripheral surface and a flanged portion, which projects in a radial outward direction from the peripheral surface and abuts the second sealing member; and
a coil spring inserted into the liquid filter interior cavity and compressed between the bottom of the second opening and the flanged portion, which is pressed by the spring to the abutment surface.

2. The liquid filter according to claim 1, wherein the liquid filter is a fuel filter.

3. The liquid filter according to claim 2, wherein the first cup-shaped member and the second cup-shaped member have round cross-sections, the filter element is a disk-shaped filter element, the first seal member is a first seal O-ring, and the second seal member is a second seal O-rings.

4. The liquid filter according to claim 3, wherein the first connection member is a first thread and the second connection member is a second thread.

5. The liquid filter according to claim 4, wherein the disk-shaped filter element has a first end face, a second end face, and a plurality of ribs that extend outward from the first end face and the second end face of the disk-shaped filter element.

6. The liquid filter according to claim 5, wherein the disk-shaped filter element is made from a pleated stainless-steel mesh laminate.

7. The liquid filter according to claim 4, wherein the first thread is an internal thread and the second thread is an external thread.

8. The liquid filter according to claim 5, wherein the first thread is an internal thread and the second thread is an external thread.

9. The liquid filter according to claim 2, wherein the first cup-shaped member is a filter body, the second cup-shaped member is a filter body cap, the first connection member is a first thread and the second connection member is a second thread.

10. The liquid filter according to claim 9, wherein the first thread is an internal thread and the second thread is an external thread.

11. The liquid filter according to claim 10, wherein the filter body and the filter body cap have round cross-sections, the filter element is a disk-shaped filter element, the first seal member is a first seal O-ring, and the second seal member is a second seal O-rings.

12. The liquid filter according to claim 11, wherein the disk-shaped filter element has a first end face, a second end face, and a plurality of ribs that extend outward from the first end face and the second end face of the disk-shaped filter element.

13. The liquid filter according to claim 12, wherein the disk-shaped filter element is made from a pleated stainless-steel mesh laminate.

14. The liquid filter according to claim 13, wherein the filter body and the filter body cap are made from with surfaces finished by anodizing, the filter element is made from pleated 304 stainless steel mesh layers having filtering holes of 0.01 mm in diameter.

15. A liquid filter comprising:
A first cup-shaped member of a circular cross-section having on one end a first opening that has a bottom surface and a predetermined diameter, a first fitting on the other end for connecting the first cup-shaped member to a liquid receiver device, a second opening having a diameter smaller than said predetermined diameter and deepening from the bottom of the first opening toward the first fitting, and an annular shoulder left on the bottom surface of the first opening after the formation of the second opening, the first cup-shaped member having a first thread;
a second cup-shaped member having on one end a third opening that has a bottom surface, a second fitting on the other end for connecting the second-cup shape member to a liquid supplier device, and a second thread engageable with the first thread of the first cup-shaped members, one of the first thread and the second thread having a front end and another one having a rear end;
a liquid filter interior cavity defined by the first cup-shaped member and the second cup-shaped member when they are screwed together to form a threaded connection by moving the front end of one of the first thread and the second thread toward the rear end of another of the first thread and the second thread;
a first seal O-ring, which is placed between the front end of one of the first thread and the second thread and the a rear end of another one of the first thread and the second thread and which is deformed in a radial outward direction by being squeezed between the front end of one of the threads and the rear end of another one of the threads to seal the threaded connection against penetration of liquid therethrough toward the first fitting, when the threaded connection is tightened to a tightened state at which the front end of one of the first thread and the second thread is moved to a position nearest to the rear end of another of the first thread and the second thread;
a disk-shaped filter element having a first end face, a second end face, an outer peripheral surface, and an annular flange projecting in a radial outward direction from the peripheral surface, and a plurality of ribs that extend outward from the first end face and the second end face of the disk-shaped filter element;
a second seal O-ring that is placed into the annular groove, the annular groove having a depth and the second seal O-ring has a cross-section diameter that is greater than the depth of the groove ; and
a coil spring, which is inserted into the liquid filter interior cavity and which in said tightened state of the threaded connection is compressed between the bottom of the third opening and the second end face of the flange of the disk-shaped filter element, whereby the first end face of the flange is pressed to the second seal O-ring and thus fixes the disk-shaped filter element in place and prevents the liquid from passing around the disk-shaped filter element.

16. The liquid filter according to claim 15, wherein the liquid is fuel, and the liquid filter is a fuel filter.

17. The liquid filter according to claim 16, wherein the first cup-shaped member is a filter body, the second cup-shaped member is a filter body cap, the first thread is an external thread, and the second thread is an internal thread engageable with the external thread.

18. The liquid filter according to claim 17, wherein the disk-shaped filter element is made from a pleated stainless-steel mesh laminate.

19. The liquid filter according to claim 18, wherein the filter body and the filter body cap are made from aluminum with surfaces finished by anodizing, the filter element is made from a pleated stainless steel mesh layers.

20. The liquid filter according to claim 19, wherein the pleated stainless-steel mesh laminate has filtering holes of 0.01 mm in diameter.
